(19) United States
(12) Patent Application Publication
(10) Pub. No.: US 2017/0164786 A1
(43) Pub. Date: Jun. 15, 2017

(54) Shredder and Shredding Method

(71) Applicant: Joshua Camitta, New York, NY (US)

(72) Inventor: Joshua Camitta, New York, NY (US)

(21) Appl. No.: 14/963,334

(22) Filed: Dec. 9, 2015

(51) Int. Cl. A47J 42/40; A24B 7/06; G01G 19/52; G01G 23/36; A47J 42/14; B02C 23/10

(52) U.S. Cl. CPC A47J 42/40; A47J 42/14; B02C 23/10; G01G 19/52; G01G 23/36; A24B 7/06

(57) ABSTRACT

A shredder has a pair of plates with interdigitated teeth that can be relatively rotated for shredding vegetative material. A receptacle mounted in a housing can hold vegetative material shed from a location between the pair of plates. A screen in the receptacle can separate fine material and store it at a relatively low position for later usage. A weighing device mounted at the housing can weigh vegetative material in the receptacle.

### BACKGROUND OF THE INVENTION

1. Field of the Invention

The present invention relates to apparatus and methods for shredding, grinding, comminuting and weighing vegetative material.

2. Description of Related Art

Herbs, tobacco and other vegetative material will often be shred or ground just before being used, in order to assure freshness of the shredded/ground material. In this specification methods and apparatus for grinding and comminuting are deemed to include methods and apparatus for shredding.

Often users will want to screen ground or shredded material and separate it into fine and coarser materials that have different properties and usefulness.

Measuring the amount of shredded/ground material is also important to assure that a sufficient amount of the material has been prepared. On the other hand, one ought to avoid preparing an excessive amount. While the excess might be stored for later use, this material will tend to quickly lose moisture and freshness and thus become unsatisfactory.

While food processors, blenders and other devices can comminute vegetative material, they tend to be large and occupy significant storage space. Likewise many weighing devices exist but these can again be bulky. Sifters exist but these are not easily used to separate comminuted material in a desirable manner. In addition, finding storage space for a separate grinder/shredder, sifter, and weighing device can often be difficult. Moreover, often one would like to be able to easily transport these devices and use them in situations where electricity or other external power sources are unavailable.

Known weighing devices have zeroing features. For example, a container may be placed on a scale before using a zeroing or tare function. Basically, the weight of the container is eliminated and the displayed weight is compensated to indicate only the weight of the contents of the container.

See also U.S. Pat. Nos. 3,721,361; 3,858,815; 4,003,166; 4,111,212; 4,304,363; 4,538,355; 4,605,175; 4,789,106; 4,858,709; 5,174,403; 5,329,069; 5,386,944; 5,522,556; 5,603,458; 6,736,342; 6,775,919; 6,834,817; 7,422,170; 7,422,170; 7,422,170; 8,393,563; and 8,733,679; as well as US Patent Application Publication Nos. 2011/0147504; 2012/0259336; and 2014/0261471;

### SUMMARY OF THE INVENTION

In accordance with the illustrative embodiments demonstrating features and advantages of the present invention, there is provided a shredder for shredding vegetative material. The shredder has a housing and a first plate mounted at the housing. The first plate has a working face with a first plurality of teeth. The shredder also has a second plate with an opposing face. This opposing face has a second plurality of teeth interdigitated with the first plurality of teeth. The first plate and the second plate are relatively rotatable for shredding the vegetative material. Also included is a receptacle mounted in the housing for holding vegetative material shed from a location between the first and the second plate. The shredder also has a weighing device mounted at the housing for weighing vegetative material shed from a location between the first and the second plate

According to another aspect of the present invention, there is provided a method for shredding vegetative material. The method employs a weighing device, a receptacle, and a pair of plates with interdigitated teeth. The method includes the step of placing vegetative material between the pair of plates. The pair of plates are relatively rotated to interdigitate their teeth and shred the vegetative material. The method also includes the step of delivering vegetative material shredded by the teeth of the pair of plates to the receptacle. Another step is screening vegetative material in the receptacle to separate fine material and store it at a relatively low position for later usage. The method also includes the step of weighing vegetative material in the receptacle with the weighing device.

### BRIEF DESCRIPTION OF THE DRAWINGS

The above brief description as well as other objects, features and advantages of the present invention will be more fully appreciated by reference to the following detailed description of illustrative embodiments in accordance with the present invention when taken in conjunction with the accompanying drawings, wherein:

FIG. 1 is an exploded, perspective view of a shredder/grinder with its access door open to receive a receptacle, in accordance with principles of the present invention.

FIG. 2 is a perspective view of the holder of FIG. 1;

FIG. 3 is an elevational view of the holder of FIG. 2;

FIG. 4 is a plan view of the working face of a first plate of FIG. 1;

FIG. 5 is a plan view of the opposing face of a second plate of FIG. 1;

FIG. 6 is an exploded view of the access door and dispensing door of FIG. 1;

FIG. 7 is a top view of the weighing device of FIG. 1;

FIG. 8 is an exploded view of a receptacle that is to be installed in the arrangement of FIG. 1;

FIG. 9 is an assembled view of the apparatus of FIGS. 1 and 6 showing the receptacle about to be installed in the housing and with the access door removed from the housing for simplification purposes;

FIG. 10 is a detailed, fragmentary, perspective view of the alignment stub at the top center of the device of FIG. 7;

FIG. 11 is a bottom view of the alignment stub of FIG. 10;

FIG. 12 is a side view of the stub of FIG. 10; and

FIG. 13 is detailed, fragmentary, perspective view of a socket in the bottom of the receptacle of FIG. 8.

### DETAILED DESCRIPTION

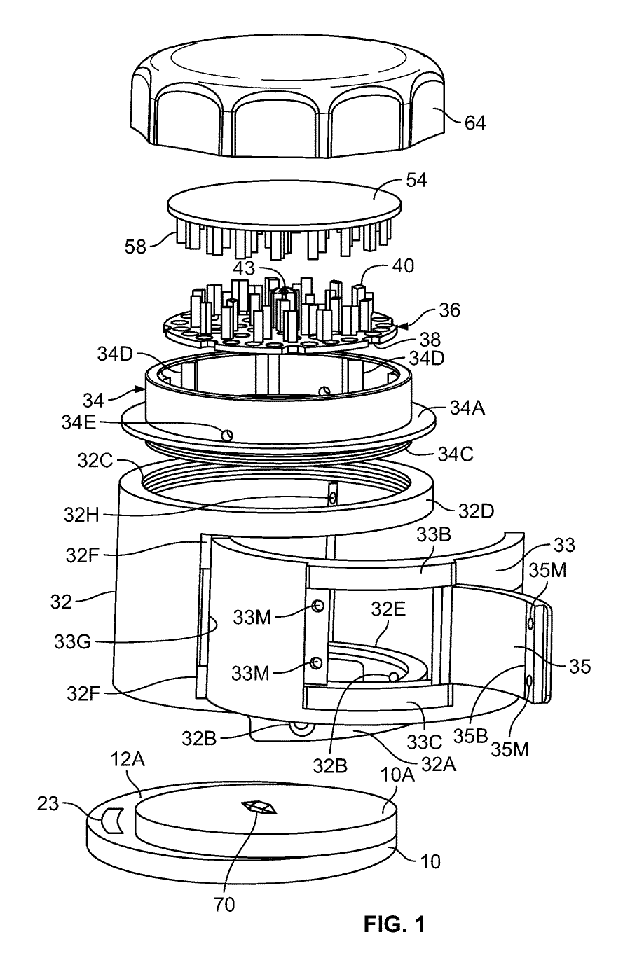

Referring to FIG. 1, the illustrated apparatus is part of a shredder and includes a weighing device 10 having a protruding control panel 12A. Device 10 has a weighing platform 10A.

Housing 32 has a generally cylindrical shape and has a skirt 32A that fits around weighing platform 10, extending about 180°. Skirt 32A can be secured in place by screws (shown hereinafter), which are inserted through a number of screw holes 32B. The upper mouth of housing 32 has internal threads 32C.

The back of housing 32 has a door opening bordered on top by lintel 32D and on the bottom by sill 32E. The right and left vertical edges of this opening are angularly spaced by about 180° with the right edge having a pair of magnets 32H (one visible in this view) and a pair of hinge knuckles 32F.

Holder 34 is a cylindrical sleeve with screw holes 34E. Holder 34 has flange 34A located above externally threaded collar 34C, which collar can be threaded into internal threads 32C of housing 32. Holder 34 has a number of equiangularly spaced ridges 34D.

First plate 36 is shown as a circular disk with eight peripheral notches 38 that are designed to slide over ridges 34D in holder 34. Plate 36 can be secured in place in holder by means of screws (net shown) threaded into screw holes 34E. A first plurality of teeth 40 in the form of four sided prisms, project perpendicularly from the upper working face of plate 36. A similarly projecting center hub 43 is slightly taller than teeth 40.

Second plate 54 has the same thickness and outside diameter as plate 36 but lacks notches. In this embodiment plates 36 and 54 each have a diameter of 2.5 inches (6.3 cm) and a thickness of 0.09 inch (2.3 mm), although different dimensions may be employed in other embodiments.

A second plurality of teeth 58 in the form of four sided prisms project perpendicularly from the lower opposing face of plate 54. Teeth 58 are herein referred to as a second plurality of teeth in second plate 54.

Cup-shaped cover 64 is shaped to receive plate 54, which is glued in place. Consequently, the turning of cover 64 will cause plate 54 to rotate.

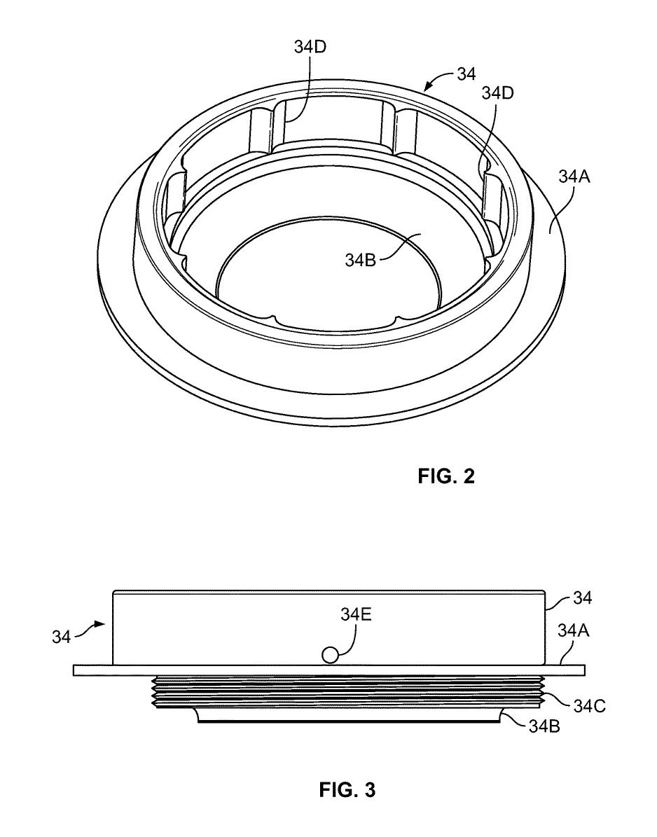

Referring to FIGS. 2 and 3, previously mentioned ridges 34D on the inside of holder 34 are located above chute 34B. Chute 34B has a funnel-like shape that and projects beyond external threads 34C.

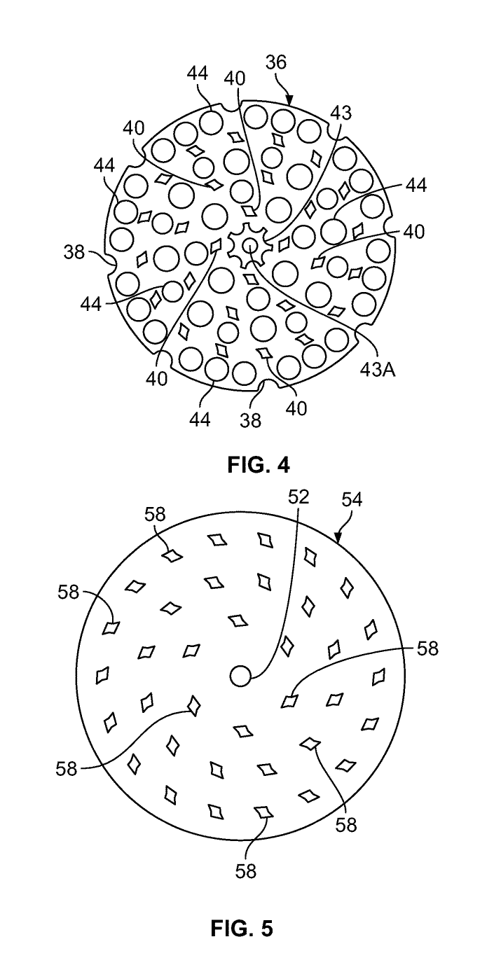

Referring to FIG. 4, previously mentioned plate 36 is shown as a circular disk with eight peripheral notches 38. Teeth 40 are arranged in three evenly spaced, circular, concentric rows, namely (1) an outer annular row having sixteen equiangularly spaced teeth 40; (2) a middle annular row having eight equiangularly spaced teeth 40; and (3) an inner annular row having four equiangularly spaced teeth 40. For each row, teeth 40 have a consistent radial placement

Each of the teeth 40 have four sides: an inside, an outside, a clockwise facing side, and a counterclockwise facing side. The clockwise and counterclockwise facing sides are concave and form acute cutting edges at a cutting angle of about 35°, although different angles may be employed in other embodiments.

Plate 36 also has through holes 44 arranged in three circular, concentric rows as follows: (1) an outer annular row having twenty four spaced holes 44 arranged in eight equiangularly spaced trios, a trio being located between each adjacent pair of notches 38; (2) a middle annular row having sixteen equiangularly spaced holes 44, specifically eight small holes alternating with eight larger holes; and (3) an inner annular row having eight angularly spaced holes 44.

Hub 43 is a prismatic column having a star-shaped cross-section. Hub 43 is located at the center and has an embedded central magnet 43A.

Referring to FIG. 5, previously mentioned plate 54 is shown as a circular disk with a central, flush, embedded magnet 52, and upright teeth 58. Teeth 58 are arranged in three evenly spaced, circular, concentric rows, namely (1) an outer annular row having eighteen equiangularly spaced teeth 58; (2) a middle annular row having twelve equiangularly spaced teeth 58; and (3) an inner annular row having six equiangularly spaced teeth 58. For each row the teeth 58 have a consistent radial placement and the rows are spaced so they can pass by or between the previously mentioned rows of teeth (teeth 40 of FIG. 4). Moreover, the three rows of teeth 58 have a radial spacing that allows them to pass over holes 44 of FIG. 4.

Teeth 58 have a shape similar to teeth 40, but appear as mirror images when assembled and viewed along the same vertical direction. Teeth 40 and 58 may be arranged similarly to those shown in U.S. Pat. No. 8,733,679, which is incorporated herein by reference.

In this embodiment teeth 40 and 58 are 0.35 inch (9 mm) tall and have a thickness in the radial direction of 0.09 inch (2.3 mm), although different dimensions may be employed in other embodiments.

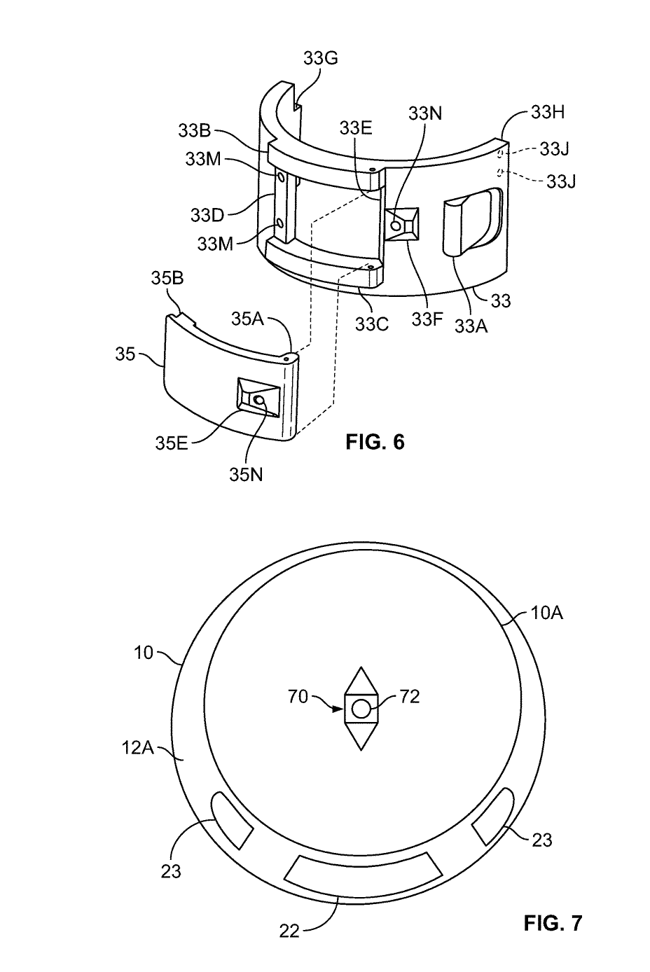

Referring to FIG. 6, access door 33 is shown as an arcuate panel with a central opening bordered by outwardly protruding lentil 33B, outwardly protruding sill 33C, outwardly protruding left jamb 33D, and right jamb 33E. Dispensing door 35 has a right rib 35A that can be hinged using hinge pins (not shown) between elements 33B and 33C, next to right jamb 33E. Dispensing door 35 has a stop 35B with a pair of inwardly facing latching elements (magnets 35M of FIG. 1) that can latch onto magnets 33M on jamb 33D of access door 33 to hold dispensing door 35 closed.

Dispensing door 35 has a magnet 35N embedded on the sloping face of external abutment 35E. Magnet 33N is embedded on the sloping face of external abutment 33F, which is located next to jamb 33E of access door 33. When dispensing door is swung open fully, magnets 33N and 35N act as latching elements for holding dispensing door 35 open.

Access door 33 has a rail 33G that is hinged between knuckles on the housing (i.e., knuckles 32F of housing 32 in FIG. 1). Rail 33G can be hinged by means of hinge pins (not shown). A finger grip 33A molded into the swinging end 33H of access door 33 has a sloped surface rising from a recessed distal end to a prominent proximal end.

A pair of magnets 33J are embedded on the inside of access door 33 at swinging end 33H, at a higher elevation than finger grip 33A. Magnets 33J act as closure elements that can latch onto housing magnets (see the magnet 32H visible in FIG. 1) to hold access door 33 closed. This relatively high elevation of magnets 32H and 33J avoids magnetic interference with the weighing device 10 (FIG. 1).

Referring to FIG. 7, previously mentioned weighing device 10 has a weighing platform 10A and control panel 12A. Panel 12A has an LCD display 22 between a pair of control buttons 23. Device 10 has an internal transducer (not shown) such as a piezoelectric component or other element that may be used as a weighing transducer.

Buttons 23 may be operated in a conventional manner to turn device 10 on and off. Buttons 23 may also be used to perform a zeroing function. For example, if an object currently resting on platform 10A is simply a container that should not be counted as a payload, device 10 can record that container weight and subtract it from future weighings.

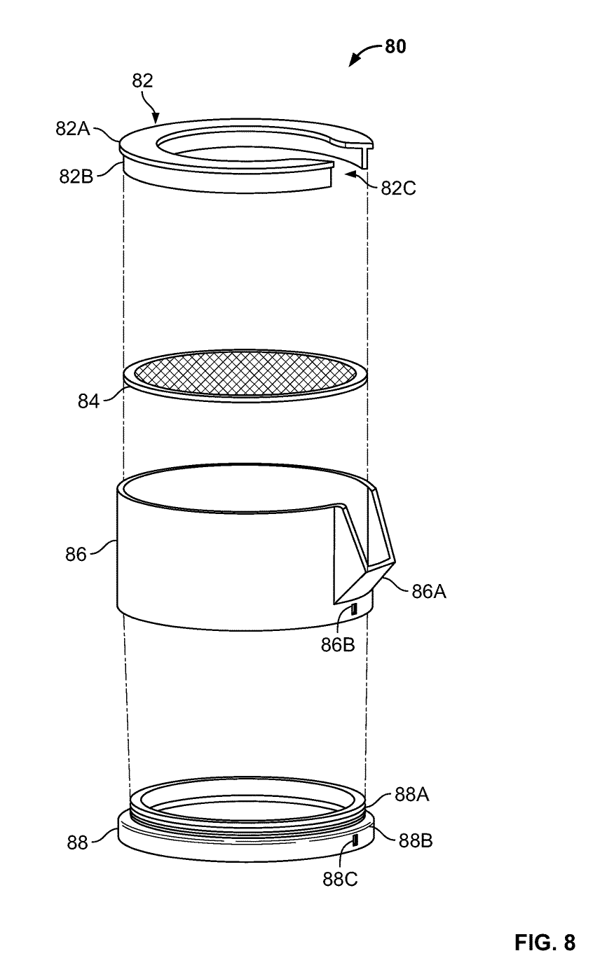

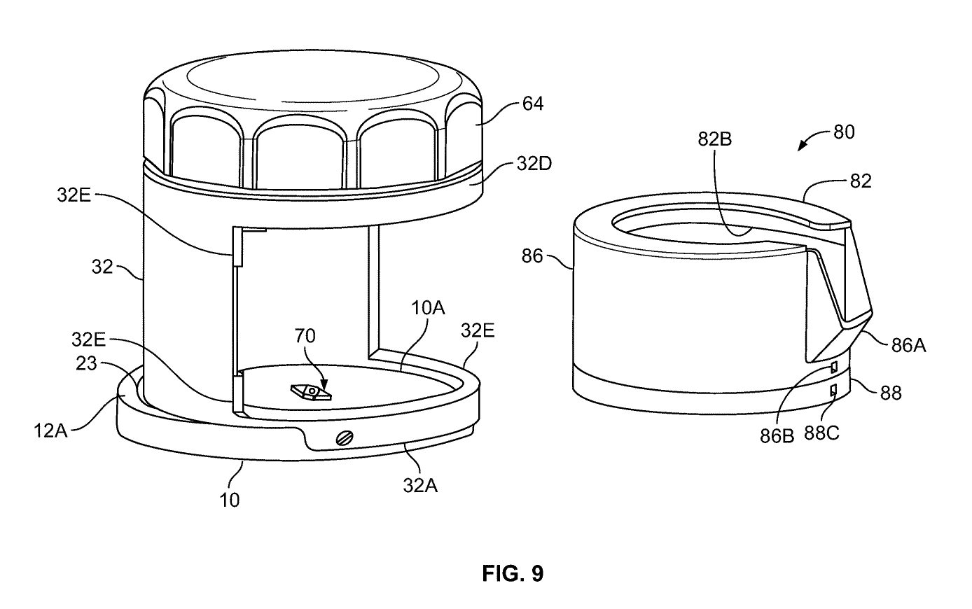

Referring to FIGS. 8 and 9, receptacle 80 includes basket 86 that is a hollow cylinder, except for a spout 86A. Screen 84 is glued in place inside basket 86 just below spout 86A. In this embodiment screen 84 was an 80 grit screen, although good results are achieved with screens in the range 50 to 120 grit. In any event, the fineness of the screen will be chosen depending on the material being graded and the desired grading.

Split sleeve 82 is slid down into the open top of basket 86 until upper flange 82A rests on the basket's rim. The split in sleeve 82 is aligned with spout 82A and encompasses about 45°.

A subjacent receiver 88 is shown as shallow cup with an externally threaded collar 88A rising from base 88B. The bottom of basket 86 has internal threads (not shown) for receiving threaded collar 88A, so that receiver 88 threadably removable and threadably installable.

Referring to FIGS. 7 and 10-12, alignment stub 70 is attached to the center of weighing platform 10A. Stub 70 is a discrete plastic element attached by gluing, although in other embodiments the stub may be made from any of a variety of materials and may be fastened in various ways; or may be an integral feature of platform 10A.

Stub 70 is for the most part a solid polyhedron with a central rectangular block section 70A located between pyramidical sections 70B and 70C. Pyramidical sections 70A and 70B each have an upper sloped surface and an opposing pair of converging side faces that are vertical (i.e., perpendicular to the surface of weighing platform 10A). The exposed side faces of block section 70A are also vertical.

Block section 70A has a through bore 70D for receiving magnet 72, which acts as a holding element. The underside of stub 70 has four equiangularly spaced grooves 70E extending radially from bore 70D to the edge of stub 70 to permit discharge of excess glue used to secure the underside of stub 70 to platform 10A.

In this embodiment stub 70 has an overall length of 0.91 inches (2.3 cm), an overall width of 0.38 inches (0.96 cm), and an overall thickness of 0.07 inches (1.8 mm), while the separation between sections 70A and 70B (i.e, the length of block section 70A) is 0.245 inches (0.62 cm). It will be appreciated that different dimensions may be used in other embodiments.

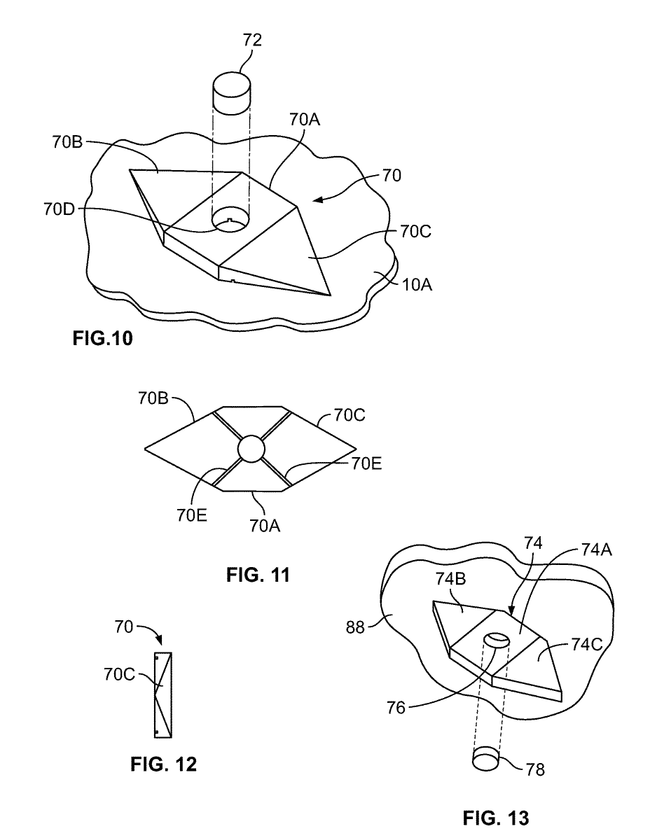

Referring to FIG. 13, the underside of receiver 88 has a socket 74 that is shaped to match the surface of previously mentioned stub 70 of FIG. 10. Specifically, socket 74 has a rectangular concavity 74A between pyramidical concavities 74B and 74C. The center of concavity 74A has a hole 76 into which magnet 78 is embedded, flush.

Stub 70 and socket 74 have vertical sides that reduces the likelihood of an applied torque causing the stub or socket to ride over each other and disconnect. Also, this verticality and close tolerances reduces play and increases the accuracy of the arrangement.

To facilitate an understanding of the principles associated with the foregoing apparatus, its operation will be briefly described. The shredder is assembled as shown in FIG. 9, but with doors 33 and 35 installed as shown in FIG. 1. The receptacle 80 is also assembled as shown in FIG. 9.

Receiver 88 is screwed onto basket 86 until its alignment mark 88C lines up with the basket's alignment indicia 86B. Receptacle 80 will then be installed inside housing 32. The alignment of marks 86B and 88C ensure that socket 74 (FIG. 13) on the underside of receiver 88 is so oriented that when stub 70 lands in the socket, spout 86A is centered in the opening of housing 32. Therefore, when access door 33 (FIG. 1) is closed, spout 86A will be centered between jambs 33D and 33E (FIG. 6) associated with dispensing door 35.

In fact, when positioning receptacle 80 so that stub 70 and socket 74 will mate, the sloping surfaces 70B and 70C of the stub will produce a camming action that will tend to rotate the receptacle into the correct orientation. Also, magnets 72 and 78 will draw stub 70 and socket 74 together, further fostering proper orientation. With the device assembled in this manner, the user may close doors 33 and 35.

The user may place weighing device 10 on a tabletop or other horizontal surface. Buttons 23 (FIG. 7) are then operated to turn device 10 on and request a zeroing routine. In response, device 10 will capture the value indicating the weight on platform 10A, which is essentially the weight of receptacle 80. That captured value will be stored as a baseline. Device 10 will then send a signal to display 22, which will indicate a zero reading.

Next the user will remove cover 64 and the attached plate 54. The user will then insert vegetative material atop plate 36. This vegetative material may be herbs, tobacco, or the like. Cover 64 and plate 54 are now depressed until magnet 52 of plate 54 snaps into magnetic engagement with magnet 43A of plate 36.

When plate 54 was snapped onto plate 36, teeth 58 were thrust downwardly to interdigitate with teeth 40. With this downward movement vegetative material will be caught between teeth 40 and 58, stretched and partially torn or shredded. The shredding process can now begin in earnest as the user grasps housing 32 with one hand and cover 64 with the other hand. By rotating cover 64 relative to housing 32, the user will cause plate 54 to rotate relative to plate 36.

If cover 64 is rotated relative to housing 32, teeth 58 will move relative to teeth 40. Consequently, vegetative material will be caught between teeth 58 and 40, stretched, and shredded. In some cases the relative rotation will be reversed. This may occur because of user preferences, or because the user angularly oscillates plate 54 relative to plate 36.

Stub 70 will keep receptacle 80 centered and away from the inside surfaces of housing 32. This will avoid receptacle 80 rising and interacting with the shredding process, which would adversely affect the accuracy of the weighing process. In addition, stub 70 will fit closely inside socket 74 and avoid any play that will detract from the operation of the shredder.

As this process continues, vegetative material will be shredded into smaller and smaller fragments. Eventually these fragments will be small enough to fall through holes 44 in plate 36. The shredded material is highly likely to fall through holes 44 since they are plentiful and teeth 40 and 58 tend to stir the shredded material. Also, since holes 40 and teeth 58 reside in common rows, these teeth tend to sweep shredded material into the holes 44.

After falling through holes 44, the shredded material is guided by chute 34B (FIG. 2) into receptacle 80. Collar 82 (FIG. 8) has a wide rim that keeps shredded material from falling outside receptacle 80.

Weighing device 10 will respond to this falling material by displaying on screen 22 (FIG. 7) the increasing weight. The user will observe display 22 and if the weight value is inadequate will continue to shred the material by relatively rotating cover 64 and housing 32.

In some cases, all the vegetative material between plates 36 and 54 will be shredded and discharged through holes 44. The user will then notice the lack of resistance. In fact, because hub 43 is higher than surrounding teeth 40, plate 54 can freewheel, with its magnet 52 spinning on magnet 43A hub 43. At this time the user may want to shred more vegetative material and will again remove cap 64 and plate 54 and reload the shredder as described above.

Eventually, sufficient material will fall into receptacle 80 so that weighing device 10 will show on display 22 the weight value desired by the user. The user may now open dispensing door 35, thereby releasing magnets 35M from magnets 33M (FIG. 1). Door 35 may be swung fully open so that magnet 35N locks onto magnet 33N (FIG. 6), keeping the door open so it will not interfere with the dispensing operation.

With dispensing door 35 held open, the user may tilt the shredder so that the shredded material is dispensed by spout 86A through door 33. The protruding lintel 33B and protruding sill 33C will guide the exiting material and avoid material falling back into housing 32 to the outside of receptacle 80.

The dispensed material may either be delivered to a container or directly to an intended application. For example, if herbs were shredded, these shredded herbs may be delivered to a bowl or pot being used to prepare a dish. If tobacco was shredded, the shredded material may be directly delivered to paper that is then rolled before lighting and smoking the tobacco.

When the vegetative material is shredded, certain fine material may be dislodged. For example fine plant structure such as pollen may be dislodged and will tend to fall to the bottom of receptacle 80. Sufficiently fine material will pass through screen 84 and land in receiver 88. In some case the user will leave the shredded material in receptacle 80, will open access door 33, remove receptacle 80, and shake it to loosen fine particles, allowing them to fall through screen 84.

Whether, the vegetative material above screen 84 has been dispensed past door 35 or not, receptacle 80 can be removed and receiver 88 can be unscrewed from basket 86. This allows the contents of receiver 88 to be immediately used or stored for later use. Thereafter, receiver 88 can be reinstalled on basket 86. Any shredded material remaining in housing 80 can be discharged through spout 86A, before returning receptacle 80 to housing 32, and closing door 33.

Before putting the shredder away, a user may again lift cap 64 and plate 54 and then shake or brush out any vegetative material remaining between teeth 40 or between teeth 58. Thereafter, plate 54 and cover 64 can be replaced in the manner described previously.

At any time, one can open access door 33 in order to remove and clean receptacle 80. Also, any loose material that missed receptacle 80 and fell into housing 32 can be swept out.

Also, the foregoing equipment can be used as an independent weighing apparatus. Weighing device 10 can be zeroed as described above before removing receptacle 80. Next, material to be weighed can be placed inside the removed receptacle 80. Thereafter, receptacle 80 can be returned to housing 32 with socket 74 (FIG. 13) placed over alignment stub 70. Access door 33 can be dosed, but such closure is not mandatory.

With receptacle 80 resting on weighing platform 10A, weighing device 10 will weigh and display just the contents of the receptacle, because the weight of the receptacle itself will be subtracted as a result of the zeroing process.

It is appreciated that various modifications may be implemented with respect to the above described embodiments. The alignment stub need not have a diamond shape with pyramidical features, but some embodiments may employ a stub with a different polyhedral shape or with some smoothly curved surfaces. In still other embodiments, multiple stubs may be employed to enhance the accuracy and stability of the placement of the receptacle. While the above teeth are shown as perpendicular, four-sided prisms, in other embodiments the teeth can be tilted, blade-like, T-shaped, extend outwardly along a curved axis, etc. Also, the number and placement of teeth can be varied depending upon the size of the device, how fine one wishes to shred material, reliability, etc. While the teeth are shown mounted on flat plates, in some embodiments the plates may be dome shaped, with a convex side of one plate facing the concave side of the other plate. In addition, the dimensions, proportions, and shapes of the various components illustrated herein may be varied depending on the desired capacity, strength, reliability, etc. In some embodiments, the disclosed screen will be replaceable to allow the user to decide how fine the screened material ought to be. In still other embodiments, multiple screens may be employed to separate the particulate into different grades of fineness. In addition the illustrated magnets may be replaced with other types of latches for holding a door open or closed. Also, depending on the requirements of strength and reliability, the shredder can be made from metal, plastics, ceramics, composite materials, etc.

Obviously, many modifications and variations of the present invention are possible in light of the above teachings. It is therefore to be understood that within the scope of the appended claims, the invention may be practiced otherwise than as specifically described.

1. A shredder for shredding vegetative material, comprising:
a housing;
a first plate mounted at said housing, said first plate having a working face with a first plurality of teeth;
a second plate having an opposing face with a second plurality of teeth interdigitated with said first plurality of teeth, said first plate and said second plate being relatively rotatable for shredding said vegetative material;
a receptacle mounted in said housing for holding vegetative material shed from a location between said first and said second plate; and
a weighing device mounted at said housing for weighing vegetative material shed from a location between said first and said second plate.

2. A shredder according to claim 1 wherein said housing includes:
a dispensing door for allow dispensing of vegetative material from said receptacle.

3. A shredder according to claim 1 wherein said housing includes:
an access door sized to allow said receptacle to be inserted into and removed from said housing.

4. A shredder according to claim 3 comprising:
a dispensing door mounted on said access door to allow dispensing through said access door of vegetative material located in said receptacle.

5. A shredder according to claim 3 comprising:
a screen mounted in said receptacle for allowing downward passage of fine material.

6. A shredder according to claim 5 wherein said receptacle has a removable subjacent receiver for capturing for later usage fine material that passed through said screen.

7. A shredder according to claim 5 comprising:
a dispensing door mounted on said access door to allow dispensing through said access door of vegetative material located in said receptacle above said screen.

8. A shredder according to claim 3 wherein said access door has a closure element for allowing said access door to be held closed magnetically, said closure element being located at an upper portion of said access door to increase separation from, and prevent magnetic interference with, said weighing device.

9. A shredder according to claim 4 wherein said receptacle has a spout aligned with said dispensing door.

10. A shredder according to claim 9 wherein said access door has an outwardly protruding lintel and an outwardly protruding sill for receiving between them said dispensing door, and for guiding vegetative material dispensed from said spout of said receptacle.

11. A shredder according to claim 10 wherein said dispensing door has one or more latching elements for allowing said access door to be held closed magnetically and held open magnetically.

12. A shredder according to claim 4 wherein said first plate and said second plate are held together magnetically with a separation that allows them to freely rotate in the absence of vegetative material between them.

13. A shredder according to claim 1 comprising:
a stub located between said receptacle and said weighing device.

14. A shredder according to claim 13 wherein said stub has at least one sloped upper surface and a pair of converging sides.

15. A shredder according to claim 13 wherein said stub has a holding element for magnetically holding together said receptacle and said weighing device.

16. A shredder according to claim 15 wherein said weighing device is adapted to rest on a horizontal surface with said receptacle resting on said weighing and extending vertically above said weighing device, said stub having a section with at least one vertical face.

17. A shredder according to claim 16 wherein said stub is located upon said weighing device, said stub having a pyramidical section adjoining a block section, said block section having at least one vertical face.

18. A shredder according to claim 17 wherein said receptacle has an underlying socket for mating with said stub.

19. A shredder according to claim 18 wherein said socket has an embedded magnet, said stub having a holding element adapted to be magnetically attracted to said embedded magnet.

20. A shredder according to claim 18 comprising:
a screen mounted in said receptacle for allowing downward passage of fine material, said receptacle having a threadably removable subjacent receiver for capturing for later usage fine material that passed through said screen, said receptacle having an alignment indicia spaced from said receiver, said socket being located on said receiver, said receiver having an alignment mark that is rotatable into alignment with the alignment indicia on said receptacle to indicate said socket is properly aligned.

21. A method for shredding vegetative material employing a weighing device, a receptacle, and a pair of plates with interdigitated teeth, the method comprising the steps of:
placing vegetative material between the pair of plates;
relatively rotating the pair of plates to interdigitate their teeth and shred the vegetative material;
delivering vegetative material shredded by the teeth of the pair of plates to the receptacle;
screening vegetative material in the receptacle to separate fine material and store it at a relatively low position for later usage; and
weighing vegetative material in the receptacle with the weighing device.

22. A method according to claim 21 comprising the steps of:
operating the weighing device to register zero when the receptacle is empty and resting on the weighing device;
moving the receptacle away from the weighing device and loading vegetative material into the receptacle; and
returning the receptacle to a position atop the weighing device to measure a weight that has been offset to compensate for the weight of the receptacle.

23. A method according to claim 21 employing an alignment stub between the receptacle and the weighing device, the method comprising the step of:
using the alignment stub to give a predetermined alignment between the receptacle and the weighing device.

24. A method according to claim 21 employing an alignment stub between the receptacle and the weighing device, the method comprising the step of:
using the alignment stub to center the receptacle on the weighing device to avoid physical interference with any nearby structure.

25. A method according to claim 21 employing an alignment stub with a sloped upper surface between the receptacle and the weighing device, the method employing the step of:
pressing the receptacle and the weighing device together and allowing the sloped surface of the alignment stub to cam the receptacle and the weighing device into a predetermined orientation.

26. A method for shredding vegetative material employing a weighing device, a receptacle, an alignment stub between them, and a pair of plates with interdigitated teeth, the method comprising the steps of:
using the alignment stub to give a predetermined alignment between the receptacle and the weighing device;
placing vegetative material between the pair of plates;
relatively rotating the pair of plates to interdigitate their teeth and shred the vegetative material;
delivering vegetative material shredded by the teeth of the pair of plates to the receptacle; and
weighing vegetative material delivered to the receptacle with the weighing device.
